(19) United States
(12) Patent Application Publication
(10) Pub. No.: US 2022/0302702 A1
(43) Pub. Date: Sep. 22, 2022

(54) METHOD FOR OPERATING A DATA CENTER IN AN ELECTRICAL NETWORK, AND DATA CENTER FOR CARRYING OUT SUCH A METHOD

(71) Applicant: Rolls-Royce Solutions GmbH, Friedrichshafen (DE)

(72) Inventors: Thomas Kottke, Ehningen (DE); Niko Mittelmeier, Friedrichshafen (DE)

(73) Assignee: Rolls-Royce Solutions GmbH, Friedrichshafen (DE)

(21) Appl. No.: 17/833,417

(22) Filed: Jun. 6, 2022

Related U.S. Application Data
(63) Continuation of application No. PCT/EP2020/084611, filed on Dec. 4, 2020.

(30) Foreign Application Priority Data
Dec. 6, 2019 (DE) 10 2019 219 111.8

(51) Int. Cl. H02J 3/00

(52) U.S. Cl. CPC H02J 3/003; H02J 3/007; G06Q 50/06

(57) ABSTRACT

A method for operating a data center in an electrical network, the method including the steps of: processing a plurality of calculation tasks by the data center; and assigning each one of the plurality of calculation tasks at least one of a prioritization value and a calculation complexity, the plurality of calculation tasks being processed taking into account at least one of the prioritization value and the calculation complexity and taking into account a power provision parameter of the electrical network.

### CROSS REFERENCE TO RELATED APPLICATIONS

This is a continuation of PCT application no. PCT/EP2020/084611, entitled “METHOD FOR OPERATING A DATA CENTRE IN AN ELECTRICAL NETWORK, AND DATA CENTRE FOR CARRYING OUT SUCH A METHOD”, filed Dec. 4, 2020, which is incorporated herein by reference. PCT application no. PCT/EP2020/084611 claims priority to German patent application no. 10 2019 219 111.8, filed Dec. 6, 2019, which is incorporated herein by reference.

### BACKGROUND OF THE INVENTION

### 1. Field of the Invention

The invention relates to a method for operating a data center in an electrical network, and a data center for carrying out such a method.

### 2. Description of the Related Art

Such a data center can be operated as a consumer on an electrical network, which can be supplied at least partially by volatile power generators as sources of electrical power. Such volatile power generators can be assigned in particular to the so-called regenerative energies, which may for example be photovoltaic or wind power plants. Such volatile power generators have in common that the produced electrical power fluctuates over time due to uncontrollable external influences. Stable operation of the electrical network therefore requires delivery of a controlled output. This leads to increased costs associated with the operation of such an electrical network. Moreover, cases have become known wherein certain consumers were disconnected at short notice from the network by an operator of such a network, or whose permissible power consumption was restricted. This can lead to unforeseeable or at least difficult to predict difficulties in the operation for such a consumer, for example if calculation tasks that are to be processed at short notice cannot be processed by the data center. If the electrical network has a plurality of power generators assigned to it which can be controlled in regard to their power output, it is possible that the level of efficiency of such power generators depends on the emitted power output. If necessary, these power generators are operated at reduced efficiency, especially in the event of fluctuating power demand by the consumer connected with the electrical generator.

What is needed is a method for operating a data center in an electrical network, and a data center for carrying out such a method, wherein the cited disadvantages are at least reduced, optionally do not occur.

### SUMMARY OF THE INVENTION

The present invention provides a method for operating a data center in an electrical network, which is also referred to as power grid. Thereby, a plurality of calculation tasks are processed by the data center. Each calculation task of the plurality of calculation tasks is assigned at least one parameter selected from a prioritization value and a calculation complexity; or each calculation task of the plurality of calculation tasks is assigned at least one parameter selected from the prioritization value and the calculation complexity. The calculation tasks are processed in consideration of their respective at least one parameter and a power provision parameter of the electrical network. This makes it possible when operating the data center to take into account—quasi-proactively—a state of the electrical network and/or of power generators assigned to the electrical network as sources in particular to adapt the operation to the state of the electrical network or to the state of the power generators assigned to it. The data center can thereby be advantageously included in the stability control of the electrical network, optionally without the risk that the urgently to be processed calculation task cannot be processed. Alternatively, or in addition, the processing tasks can be processed advantageously in such a way that the power generators assigned to the electrical network are operated at a high, optionally at an as high as possible efficiency.

Optionally, both parameters, that is prioritization value and calculation complexity, are taken into consideration.

An electrical network in this context is understood to be in particular a network for the provision of electrical power or energy; the electrical network is in particular an electrical energy supply network. The electrical network can be an alternating voltage or a direct voltage network. The electrical network can be designed in particular as a stand-alone network. In particular, it is herein possible that only the data center is operated as the sole consumer on the electrical network. The data center is then assigned the electrical network quasi as its own network. It is however also possible that the electrical network is designed as a stand-alone network, whereby in addition to the data center also other consumers are connected to the electrical network. Alternatively it is also possible that the electrical network is designed as an integrated grid or supra-regional network.

A calculation task is understood in particular to be an instruction for calculation or processing of data by the data center. Such a calculation task is also referred to as task. Such a calculation task may also be a partial calculation task of a superordinate overall calculation task.

A prioritization value is understood in particular to be an identifier assigned to the calculation task, identifying the urgency of the calculation task. A prioritization value can in particular be a completion date by which the result of the calculation task must be available, or by which the process of the calculation task must be completed. Such a prioritization task can in particular be specified by a customer or client of the data center.

A calculation complexity is understood in particular to be a chronological and/or energetic effort associated with the processing of the calculation task and/or a cost associated with the processing of the calculation task—possibly virtual, in other words computational. The calculation complexity can in particular be a number of calculation steps necessary for processing the calculation task or the calculation complexity may depend on the number of calculation steps required to process the calculation task.

The prioritization value and/or the calculation complexity can be specified by a customer or client of the data center, or they can be determined or specified before the start of the herein proposed method. In this case, a prioritization value and/or a calculation complexity is assigned to a processing task at the time the process is performed.

It is however also possible that, for a processing task a prioritization value and/or a calculation complexity is determined or specified—especially by the data center—at the time of performing the procedure. In this case, the prioritization value and/or the calculation complexity is assigned to the processing task.

A power provision parameter is understood in particular to be a parameter which characterizes a current or future state of the electrical network and/or of a power generator assigned to the electrical network.

The fact that the processing tasks are processed by taking into account their respective prioritization value and/or processing effort, and by taking into account the power provision parameter, means in particular that a chronological sequence in which the processing tasks are performed and optionally a parallelization of the processing tasks, is determined depending on the respective at least one parameter, that is to say prioritization value and/or calculation complexity, and depending on the power provision parameter. In particular, it is optionally determined which calculation task is processed at which point in time by the data center.

According to a further development of the present invention it is provided that the power provision parameter is a network stability parameter. This advantageously enables integration of the data center into the stability control of the electric network. In particular, in addition to calculation tasks with a higher prioritization value and/or lower calculation complexity and also calculation tasks with a lower prioritization value and/or higher calculation complexity are also optionally calculated if the network stabilization parameter indicates that more power must be drawn from the network to stabilize the electrical network; this means that in the electrical network—possibly also in the future, in the sense of a prediction—more power is offered than is consumed, so that to achieve stabilization power consumption should be increased. In contrast, only those calculation tasks with a higher prioritization value and/or lower calculation complexity are optionally processed if the network stability parameter indicates that less power may be drawn to stabilize the electrical network; that is, less power is offered in the electrical network—possibly also in the future, in the sense of a prediction—than is drawn, so that the power consumption is to be reduced for stabilization. This is possible in particular since the calculation tasks with lower prioritization value and/or higher calculation complexity are advantageously calculated if more power can be drawn from the electrical network. The data center can thus be used advantageously as a control power sink to stabilize the electrical network in that it takes increased output during times of power peaks in the electrical network. It can however also be used as a—at least virtual—control power source by quasi releasing power requirements during times of reduced output in the electrical network, in other words taking or drawing less electric power output.

A higher prioritization value is herein understood to be a prioritization value which, compared to a prioritization value of another calculation task indicates a higher urgency of a calculation task. In contrast, a lower prioritization value is understood to be a prioritization value which, compared to a prioritization value of another calculation task indicates a lower urgency. Similarly, the terms “higher” and “lower” are to be understood as relative specifications in relation to the calculation tasks with regard to the calculation complexity.

According to a further development of the invention, the power provision parameter—in particular alternatively or in addition to a network stability parameter—represents a degree of efficiency of a power generator for the electrical network. Particularly optionally, a plurality of efficiency levels of a plurality of power generators for the power grid are considered as the power provision parameter, wherein the calculation tasks are processed in such a way that the efficiency levels of the largest possible number of power generators are as high as possible over an extended time period as possible. In particular, an overall efficiency of power generators connected to the electrical network is optionally optimized, especially maximized. If it is known in which power range a given power generator operates at optimum efficiency, the calculation tasks can be handled accordingly, in particular they can be scheduled with regard to their processing in such a way that the power generators operate in their optimum efficiency range. In particular, processing of the calculation tasks is optionally scheduled so that the power generators are optionally always operated at their optimum efficiency level. This includes that at certain times only a reduced number of power generators are operated while a complimentary sub-set of power generators can be turned off. Optionally, the number of the driven power generators and processing of the calculation tasks are therein coordinated in such a way that the power generators which are being operated can be operated at their optimum efficiency. For this purpose, calculation tasks with a lower prioritization value can be postponed, so that power generators can also be used to capacity at a later time.

Alternatively or in addition, the power provision parameter is optionally an operating point of at least one power generator for the network. Optionally a plurality of operating points of a plurality of power generators are considered. Optionally, an overall operating point of all power generators associated with the electrical network are considered.

A power generator can in particular be an internal combustion engine which is drive-actively connected to an electric machine operated as a generator, wherein the electric machine is connected to the electrical network. Such a combination of internal combustion engine and electric machine is also referred to as a genset. However, such a power generator can also be—in particular in a direct voltage network, but not limited thereto—an electrochemical cell, in particular a fuel cell, a battery, a photovoltaic system, or any other suitable power generating or power provision source.

According to a further development of the invention, it is provided that the network stability parameter is selected from a group consisting of a network frequency in the electrical network, a current strength in the electrical network, an electrical voltage in the electrical network, a storage state of at least one energy storage device connected to the electrical network, and a target load for the data center. The parameters mentioned herein allow an assessment of the stability of the electrical network in a particularly favorable manner. In particular, the network frequency as well as the electrical voltage are characteristic of the power currently available in the electrical network in relation to the power currently being drawn. If the network stability parameter indicates that the available power is decreasing compared to the drawn power, calculation tasks with lower prioritization value and/or higher calculation complexity are optionally postponed in the data center in order to stabilize the electrical network. If, on the other hand, the network stability parameter indicates that the power provided tends to exceed the power consumed, additional calculation tasks with a lower prioritization value and/or higher calculation complexity—in particular in addition to calculation tasks with a higher prioritization value and/or lower calculation complexity—are increasingly processed in the data center in order to stabilize the electrical network. In contrast, calculation tasks with a higher prioritization value and/or lower calculation complexity are optionally—as far as possible—always performed or, if necessary, given priority.

If the electrical network is an alternating voltage network the network frequency is particularly characteristic of the power currently available in the electrical network in relation to the power currently being drawn. If the electrical network is a direct voltage network, at least one of the other mentioned network stability parameters is used in particular.

A storage state of an energy storage device is understood in particular to be a fill level in the energy storage device, in other words, a measure of the energy available in the energy storage device, in particular in proportion to a maximum storage capacity of the energy storage device. Such an energy storage device may in particular be an electric storage device, optionally an electrochemical storage device, notably an accumulator or a battery. Such an energy storage device may however also be a water reservoir, in particular of a pumped storage power plant, a thermal storage device or another suitable storage device. The energy storage device is connected to the electrical network—possibly with additional devices—and is set up to store electrical energy from the electrical network or to release it into the electrical network. The energy does not necessarily have to be stored electrically or electrochemically.

Optionally, calculation tasks with a lower prioritization value and/or higher calculation complexity are performed in addition to calculation tasks with a higher prioritization value and/or lower calculation complexity when the storage fill level has exceeded a predetermined first, higher limit value, for example 75% of the storage capacity. In contrast, calculation tasks with a lower prioritization value and/or higher calculation complexity are optionally postponed, i.e. only calculation tasks with a higher prioritization value and/or lower calculation complexity are processed, if the storage fill level falls below a second, lower limit value, for example 30% of the storage capacity. By intelligently controlling the computing power of the data center, this advantageously enables a reduction in the storage capacity of the energy storage device, since a smaller amount of energy has to be held in reserve, i.e. stored.

A target load for the data center is understood in particular as a setpoint specified by the operator of the electrical network for a power draw from the electrical network for the data center. Thus, the operator of the electrical network can actively use the data center to control the grid stability. In this case—completely analogous to the above explanations—more calculation tasks can also be calculated with a lower prioritization value and/or higher calculation complexity if a higher target load is specified, wherein calculation tasks with a lower prioritization value and/or a higher calculation complexity are postponed, or respectively only calculation tasks with a higher prioritization value and/or a lower calculation complexity are calculated if a lower target load is specified.

According to a further development of the invention, it is provided that a power forecast for the electrical network is generated, wherein the calculation tasks are additionally processed by considering the power forecast. This advantageously allows forward-looking control of the data center, in particular with a view to the stability of the electrical network. Such a power forecast can be made in particular on the basis of weather data, especially a weather forecast, if volatile sources are assigned to the electrical network as power generators that provide weather dependent power, in particular power generators that are assigned to so-called renewable energies, for example photovoltaic or wind power plants. However, such a power forecast can also be created—additionally or alternatively—with a view to a storage state of an energy storage device of the electrical network. Alternatively, or in addition, such a power forecast may be made in regard to holidays, weekends, school vacation, general calendar events, times of day, consumer behavior on the electrical network, for example when using ways of communication or media, at public events such as elections, publication of news or stock market data and/or many other areas.

In particular, the chronological sequence of processing of the eligible tasks, optionally including parallelization of processing of calculation tasks, is determined depending on the power prediction.

According to a further development of the invention, it is provided that a schedule for the processing of the calculation tasks is established on the basis of the power forecast. Thus, advantageously, the processing of the calculation tasks is planned for the future on the basis of the power forecast. Particularly optionally, the schedule for processing the calculation tasks is optimized on the basis of the power forecast.

According to a further development of the invention, it is provided that pending processing tasks, optionally including at least one assigned characteristic, that is, the assigned prioritization value and/or the assigned calculation complexity are transmitted by the data center to the electrical network, in particular to an operator of same. Feedback from the data center to the electrical network occurs then advantageously, which benefits planning of stable operation of the electrical network. Optionally, the operation of slowly adjustable power generators connected to the electrical network is adjusted depending on the transmitted pending calculation task. In particular, power generators that are slow to regulate can be ramped down in time if it is foreseeable that the data center will consume less power in the future. On the other hand, power generators that are slow to regulate can be ramped up in a timely manner if it is foreseeable that the data center will have a higher power requirement.

The data center optionally has a plurality of computing devices interconnected in a data network, in particular a plurality of computers or servers. Communication between the individual computing devices can take place via the data network, for example, by Wake Up On LAN, or alternatively via a separate control line. The data center advantageously has a superordinate controller, for example a master computing device or a master server, which can switch individual computing devices or groups of computing devices on or off, and/or distribute the calculation tasks to the various computing devices. Optionally, groups of computing devices are switched off by switching a switch or router. Alternatively or additionally, it is possible that individual computing devices or groups of computing devices are switched off and on by switching switchable power sockets.

According to a further development of the invention, it is provided that in a optional embodiment the timing of at least one computing device in the data center, optionally the timing in a plurality of computing devices, optionally timing of all computing devices, is influenced depending on the power provision parameter. This represents a simple as well as an elegant and efficient possibility to control the processing of calculation tasks as well as to influence the power consumption of the computing devices. The timing of a computing device is to be understood herein, in particular as a calculation timing in particular a processing timing. Optionally, a timing signal for the operation of a volatile data memory, in particular a dynamic RAM, that is in particular a random access memory module, is not influenced as a function of the power provision parameter in order to avoid data losses. In this respect, it can be seen that influencing the calculation timing or processing timing in particular leads to a significant variation in power consumption.

According to a further development of the invention, it is provided that the timing rate is selected higher or lower depending on the power provision parameter. In particular, more calculation steps per unit time can be performed if the power provision parameter indicates that more power can be taken, while fewer calculating steps per unit time can be performed if the power provision parameter indicates that less power should be taken. Alternatively, it is possible for the timing to be turned on or off depending on the power provision parameter. Thus, the power consumption can be influenced, in particular in a binary manner, in that at least calculations or no calculations are performed by one computing device or even a plurality of computing devices, even all computing devices of the data center.

The timing is optionally switched on or off by a logic link, in particular a logic conjunction of a timing signal generated by a timing generator with a control signal, in particular a binary control signal, which is generated by the controller of the data center as a function of the power provision parameter. The timing signal on the one hand and the control signal on the other hand are fed as input values into an AND gate, whereby the output value of the AND gate is fed to the processor of a computing device as an effective timing signal. Thus, when the control signal is logically high, in particular 1, the timing signal of the timing generator is passed to the processor through the AND gate. If, on the other hand, the control signal is logically low, in particular 0, the AND gate blocks the forwarding of the timing signal coming from the timing generator, so that no more timing signal is supplied to the processor. Thus, the computing device including the processor no longer performs any calculations.

As already explained, in order to avoid data loss the timing signal, which is optionally also generated by the timing generator, is permanently fed to a volatile data memory, in particular it is not fed via a corresponding AND gate.

Influencing the timing signal depending on the power provision parameter has the advantage that the power draw by the data center can be reduced or increased very quickly, especially in the low ms range, in particular depending on a control speed of grid components of the computing equipment.

In another advantageous embodiment, the influence over timing can also be carried out via a software command and/or a software message.

According to a further development of the invention it is provided that cooling of the data center is controlled as a function of the power provision parameter. Thus, the cooling of the data center which typically has a higher demand for electrical power is advantageously incorporated into the control of the network stability and/or the influence of the efficiency of the at least one power generator for the electrical network. The cooling capacity is thus advantageously increased if the power provision parameter indicates that more power can be drawn; whereas the cooling capacity is reduced, if the power provision parameter indicates that less power should be drawn.

A predetermined target temperature range is especially optionally defined for cooling of the data center, said temperature range being characterized by a lower temperature limit and an upper temperature limit. Depending on the power provision parameter, cooling is optionally performed so that the data center—at higher possible power draw—is operated at the lower temperature limit of the predetermined target temperature range, whereas in the case of lesser available power, it is operated at the upper temperature range of the predetermined target temperature range. Thus, cooling capacity can be increased in times of power surpluses and can be reduced in times of low power availability. In particular, a reduction in the cooling capacity is advantageously possible in that the data center previously, during power surplus was operated at the lower temperature limit of the predetermined target temperature range, so that, in the case of a reduction in cooling capacity it only gradually approaches the upper temperature limit.

The objective is also met in that a controller, i.e. a control device is created which is designed to control a data center operated in an electrical network. The controller is arranged to control processing of a plurality of calculation tasks by way of the data center as a function of at least one parameter, selected from a prioritization value and a calculation complexity, assigned respectively to each calculation task, and as a function of a power provision parameter of the electrical network. The controller is in particular arranged for carrying out the method according to the invention or an optional embodiment of the method. In connection with the controller, the advantages already explained in connection with the method are in particular realized.

The controller optionally includes a receiving way for receiving the at least one respective parameter, that is of the prioritization value and/or of the respective calculation complexity. Alternatively or in addition, the controller optionally has an allocator which is arranged to assign at least one parameter—selected from the prioritization value and the calculation complexity—respectively to the calculation tasks.

Alternatively, or in addition the receiving way is optionally arranged to receive the power provision parameter.

The controller is designed optionally, for processing a plurality of calculation tasks on a plurality of computing devise in the data center, in particular to specify a chronological sequence and/or parallelization of the calculation tasks on the computing devices. The controller is in particular arranged to specify which calculation task is calculated at what time, in particular on which computing device.

The controller is in particular optionally arranged to distribute the calculation tasks to the individual computing devices.

The controller is optionally operatively connected to the computing equipment via a data network.

The controller is optionally moreover arranged to control the computing devices, in particular to switch them on or off individually or in groups, in particular to stop or start a calculation in the computing devices—individually or in groups. It is possible thereby for the controller to control the computing devices via the data network. However, it is also possible for the controller to be connected to the computing devices via a separate control line, in particular in order to influence a timing of the computing devices—individually or collectively. The controller is especially optionally arranged to transmit a—optionally binary—control signal to the computing devices via the control line.

The controller is optionally arranged to generate a—optionally binary—control signal for controlling the at least one computing devices optionally a control signal for each computing device.

The controller optionally includes a timing generating way, that is, a timing generator, arranged to generate a timing signal.

The controller also optionally has an element (AND gate) which is set up to receive the binary control signal and the timing signal and, in particular, to link them with one another in the sense of a logic conjunction (linking), the linking element being arranged to output an effective signal—in particular as the result of the logic conjunction—to at least one processor of a computing device. If the binary control signal is now logically high, the timing signal is passed on to the processor as an effective timing signal by the linking element, so that the processor is timed and thus operates. If, on the other hand, the binary control signal is logically low, the timing signal is not passed on through the linking element so that the effective timing signal disappears. In this case, the processor is not performing any calculations because it has not received a timing signal. Optionally, the controller has such a linking element for each computing device.

The present invention provides a data center including an inventive control or a control system according to one of the previously described examples of embodiments, and/or which is arranged for operation in an electrical network according to the inventive method or according to an optional embodiment of the method. In connection with the data center all advantages which were already explained in the context of the method were in particular realized.

The data center optionally has at least one computing device, optionally a plurality of computing devices connected to one another, in particular in a data network, and optionally to the controller.

### BRIEF DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

FIG. 1 is a schematic representation of a design example of the data center;

FIG. 2 is a schematic representation of a first design example of an arrangement of the data center in an electrical network, and at the same time a first embodiment of a method for operating the data center in the electrical network;

FIG. 3 is a schematic representation of a second design example of an arrangement of the data center in an electrical network, and at the same time a second embodiment of the method for operating the data center in the electrical network; and

FIG. 4 is a schematic representation of the data center and of the method, in particular according to the first or second embodiment.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

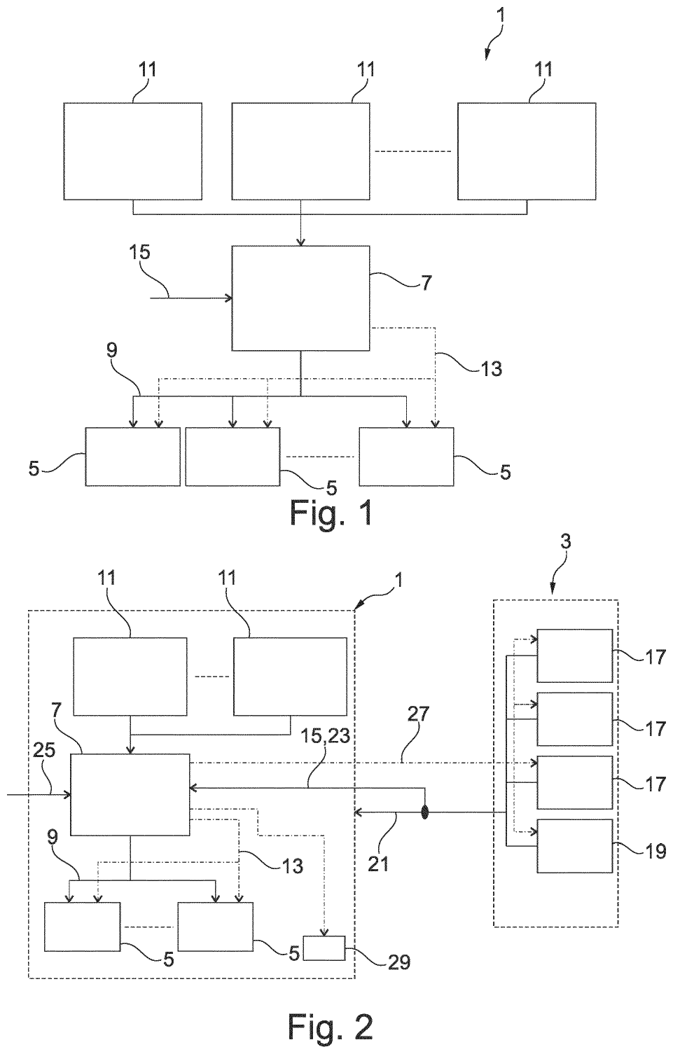

FIG. 1 shows a schematic representation of a data center 1, that is operated in an electrical network 3 shown in FIG. 2, in particular as a consumer. Data center 1 includes a plurality of computing devices 5 which may be designed in particular as a server. Data center 1 moreover includes a controller 7, that is a control device which may be provided in addition to computing devices 5 or may be integrated into one of the computing devices 5, in particular a master computing device. Controller 7 is optionally connected to computing devices 5 via a data network 9. Computing devices 5 are also optionally connected to one another via data network 9. Controller 7 is arranged to control processing of a plurality of calculation tasks 11 on computing devices 5, in particular to specify a chronological sequence and/or parallelization of calculation tasks 11 on computing devices 5. In particular, controller 7 is arranged to specify which calculation task 11 is calculated at which time, in particular on which computing device 5.

In particular, controller 7 is optionally arranged to distribute calculation tasks 11 to individual computing devices 5.

Controller 7 is optionally also arranged to turn on or off computing devices 5, in particular individually or in groups, in particular to stop or start a calculation in computing devices 5—individually or in groups. It is possible thereby, for controller 7 to control computing devices 5 via data network 9. It is however also possible that controller 7 is connected to computing devices 5 via a separate control line 13, in particular in order to influence timing of computing devices 5—individually or in groups. Controller 7 is particularly optionally arranged to transmit a—optionally binary—control signal to computing devices 5 via control line 13.

Data center 1, in particular controller 7 is arranged to carry out a process, described in more detail below.

Each calculation task 11—in particular by a data center 1 client—has assigned to it a prioritization value and/or a calculation complexity, that is, at least one parameter, or each calculation task 11 has assigned to it—optionally by controller 7—a prioritization value and/or a calculation complexity as the at least one parameter.

Controller 7 is arranged to specify the processing of calculation tasks 11 by taking into account the respective prioritization value and/or calculation complexity and taking into account a power provision parameter 15 of electrical network 3. Controller 7 is arranged in particular, to determine the time sequence of the processing of computation tasks 11, and optionally their parallelization, depending on the respective prioritization value and/or calculation complexity, and depending on power provision parameter 15.

Power provision parameter 15 is optionally a network stability parameter or an efficiency of a power generator for electrical network 3.

FIG. 2 is a schematic representation of a first design example of an arrangement of data center 1 in an electrical network 3, and a first embodiment of a method for operating data center 1 on electrical network 3.

Identical and functionally identical elements are identified in the drawings with the same reference numbers, so that reference is made in every such case to the previous description.

Electrical network 3 has a plurality of power generators 17 assigned to it which in particular may be of a different design, at least partially, wherein volatile power generators, in particular from the field of renewable energies, are also assigned to electrical network 3. For example, at least one of the power generators 17 may be designed as a wind power plant. At least one other power generator 17 may be designed as a solar or photovoltaic system. It is also possible that at least one of the power generators 17 is designed as a combination of an internal combustion engine with an electric machine, in particular as a so-called genset, which is drive-actively connected to the internal combustion engine and operated as a generator.

Moreover, electrical network 3 is optionally assigned an energy storage device 19 that is arranged to store energy from electrical network 3, irrespective of the specific physical form of energy storage, as well as to release energy to electrical network 3. In an optional embodiment, energy storage device 19 is designed as an electrochemical storage device, in particular as an accumulator or battery.

Data center 1 is connected to electrical network 3 via an electrical active connection 21. Electrical active connection 21 is optionally designed as a cable or line, or as a plurality of cables or lines.

In the first embodiment example illustrated herein, as well as in the first embodiment of the method, power provision parameter 15 is in particular a network stability parameter. Advantageously, data center 1 can thus be used to stabilize electrical network 3.

In general, the network stability parameter is optionally selected from a group consisting of a frequency, a current intensity, an electrical voltage, each optionally measured in or at electrical operative connection 21, a storage state, in particular storage fill level of energy storage device 19, and a target load for data center 1.

In the herein illustrated design example, or respectively the illustrated embodiment of the method, the net stability parameter is optionally a frequency 23 which is measured or drawn at electrical operative connection 21.

Controller 7 is designed in particular to postpone processing of calculation tasks with a lower prioritization value and/or higher calculation complexity depending on a deviation of frequency 23 from a setpoint frequency for electrical network 3 and to thereby reduce the processing power of data center 1 and the power draw from electrical network 3, or, in addition to calculation tasks with higher prioritization value and/or lower calculation complexity, to also compute calculation tasks with lower prioritization value and/or higher calculation complexity in order to increase the processing power of data center 1 and thus at the same time its power draw from electrical network 3. In particular, if frequency 23 falls below the setpoint frequency, controller 7 reduces the computing power of data center 1 and thus at the same time the power draw from the electrical network 3. If, on the other hand, frequency 23 rises above the setpoint frequency, controller 7 increases the computing power of data center 1 and thus its power draw from electrical network 3. Data center 1 is thus used in the process as at least a virtual control power source as well as a control power sink in order to stabilize electrical network 3.

Optionally, controller 7 additionally takes into account a power forecast 25 that is generated for electrical network 3 when determining the processing of calculation tasks 11. In particular, this power forecast 25 can be generated on the basis of weather data and/or the storage level of energy storage device 19. Alternatively or in addition, such a power forecast may be made with respect to holidays, weekends, school vacations, general calendar events, times of day, behavior of consumers on the electrical network, for example, in the use of communication ways or media, public events such as elections, publications of news or stock exchange data, and/or many more.

Controller 7 establishes especially optionally a schedule for processing of calculation tasks 11 based on power forecast 25, and particularly optionally, it optimizes the schedule on the basis of power forecast 25. Thus, advantageously, the future processing of calculation tasks 11 can be coordinated with the predicted power output of electrical network 3.

Controller 7 optionally transmits a feedback 27 to electrical network 3 or to an operator of the electrical network regarding remaining calculation tasks, optionally including their respective at least one parameter, that is prioritization value and/or calculation complexity. This feedback 27 is then optionally used to adapt slowly adjusting power generators 17 of electrical network 3, according to future predicted power draw by data center 1.

Data center 1 is also optionally assigned a cooling system 29, which is optionally also controlled by controller 7 depending on power provision parameter 15. Thus, cooling 29 can advantageously also be included in the stabilization of electrical network 3.

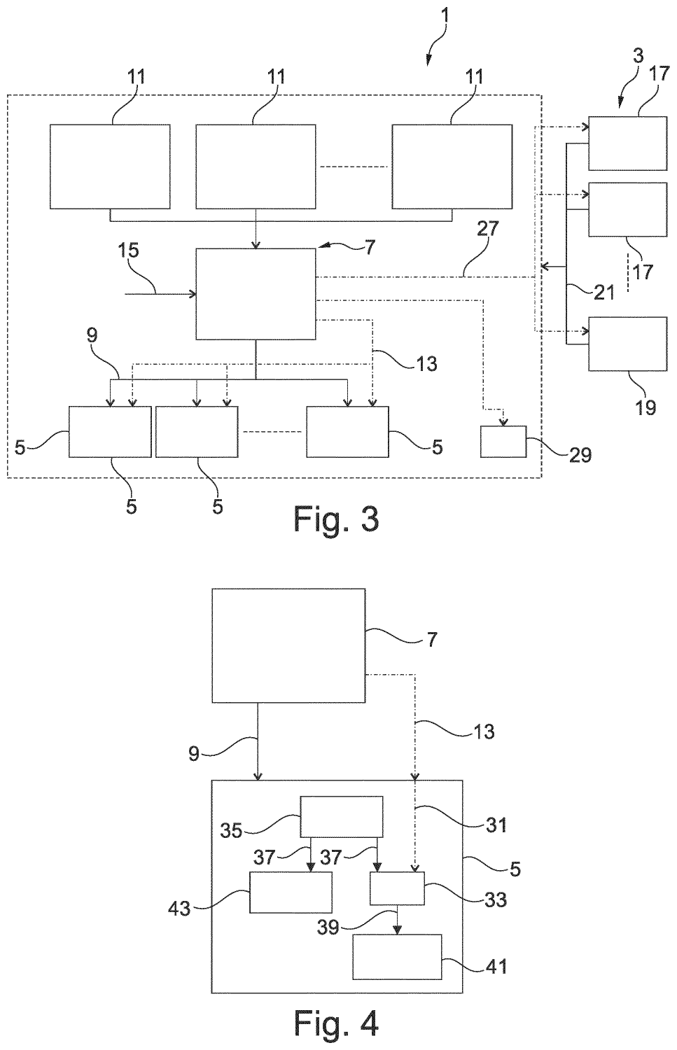

FIG. 3 shows a schematic representation of a second design example of an arrangement of data center 1 on an electrical network 3 as well as a second embodiment of the method for operating data center 1 on electrical network 3. In this second design example or respectively the second embodiment of the method, power provision parameter 15 is a degree of efficiency of power generators 17, in particular an overall efficiency level of power generators 17, in particular an overall efficiency of all power generators 17. In this case, electrical network 3 optionally includes a plurality of power generators 17, the efficiency of which depends on the power generated or respectively drawn. Optionally, all power generators 17 of electrical network 3 are power generators whose efficiency depends on the generated or drawn power. Such a power generator 17 is, for example, a genset, but also an electrochemical cell, in particular a fuel cell, or battery.

The processing of calculation tasks 11 is specified by controller 7 in such a way that power generators 17, or at least currently activated power generators 17, are operated at their optimum efficiency or at least close to their optimum efficiency. In particular, the overall efficiency of power generators 17 is optionally optimized by appropriate planning of the processing of calculation tasks 11 by controller 7.

Optionally, a feedback 27 to electrical network 3 occurs also in this case. In particular, it is possible that controller 7 can switch individual power generators 17 on or off

In particular, in the design example according to FIG. 3, electrical network 3 is designed optionally as a stand-alone network and is assigned to data center 1 as the sole consumer. In the design example according to FIG. 2, electrical network 3 can also be designed as a stand-alone network. It is however also possible, that electrical network 3 is designed as a supra-regional network, in part as an interconnected network. The embodiment according to FIG. 3 is especially suitable for an electrical network 3, designed as a direct voltage network.

FIG. 4 shows a schematic representation of a detail of data center 1 as well as of the method for operating data center 1 on electrical network 3, wherein this detail can be implemented accordingly in data center 1 according to FIG. 1 as well as particularly also in the first embodiment according to FIG. 2 and in the second embodiment according to FIG. 3.

Specifically, FIG. 4 shows an especially optional embodiment, illustrating as to how with the assistance of control line 13, in particular by way of a binary control signal 31 transmitted via control line 13 the computation of calculation tasks 11 in one of the computing devices 5 can be started or stopped.

For this purpose, binary control signal 31 is linked in an AND element 33 (AND gate) with a timing signal 37 generated by a timing generator 35, the AND element 33 outputting an effective timing signal 39 to a processor 41 of computing device 5. If binary control signal 31 is logically high, timing signal 37 is passed to processor 41 as an effective timing signal 39 by the AND member 33 so that processor 41 is timed and thus operates. On the other hand, if binary timing signal 31 is logically low, timing signal 37 is not passed through AND element 33 so that effective timing signal 39 disappears. Processor 41 does then not perform any calculations because it does not receive a timing signal.

In this way, the energy consumption of computing device 5 can be reduced or increased very efficiently and at the same time quickly, and the processing of calculation tasks in computing device 5 can be started or stopped.

Timing generator 35 optionally also generates timing signal 37 for a volatile data memory 43, in particular a dynamic RAM. In this case, timing signal 37 is not stopped or inhibited for volatile data memory 43 in order to avoid data loss, in particular by continuing to operate a refresh mechanism.

In general, controller 7 is optionally set up to influence the timing of at least one computing device 5 as a function of power provision parameter 15, in particular to select the timing higher or lower depending on power provision parameter 15 or—as specifically shown here—to switch it on or off

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating a data center in an electrical network, the method comprising the steps of:
processing a plurality of calculation tasks by the data center; and
assigning each one of the plurality of calculation tasks at least one of a prioritization value and a calculation complexity, the plurality of calculation tasks being processed taking into account at least one of the prioritization value and the calculation complexity and taking into account a power provision parameter of the electrical network.

2. The method according to claim 1, wherein the power provision parameter is a network stability parameter.

3. The method according to claim 2, wherein the power provision parameter is at least one of a degree of efficiency and an operating point of at least one power generator for the electrical network.

4. The method according to claim 2, wherein the network stability parameter is selected from a group consisting of a frequency, a current intensity, an electrical voltage, a storage state of an energy storage device, and a target load for the data center.

5. The method according to claim 1, wherein a power forecast for the electrical network is generated, wherein the plurality of calculation tasks are additionally processed by considering the power forecast.

6. The method according to claim 5, wherein a schedule for processing the plurality of calculation tasks is optimized based on the power forecast.

7. The method according to claim 1, wherein the plurality of calculation tasks, with at least one of respectively the prioritization value which has been assigned and respectively the calculation complexity which has been assigned, are transmitted by the data center to the electrical network.

8. The method according to claim 1, wherein a timing of at least one computing device in the data center is influenced as a function of the power provision parameter.

9. The method according to claim 8, wherein the timing one of is selected higher, is selected lower, and is switched one of on and off, depending on the power provision parameter.

10. The method according to claim 1, wherein a cooling of the data center is controlled as a function of the power provision parameter.

11. A controller configured for controlling a computing center operated in an electrical network, the controller comprising:
the controller, which is configured for controlling a processing of a plurality of calculation tasks by the computing center (1) depending on at least one of a prioritization value respectively assigned to each one of the plurality of calculation tasks and a calculation complexity respectively assigned to each one of the plurality of calculation tasks, and (2) as a function of a power provision parameter of the electrical network.

12. A data center, comprising:
a controller configured for controlling a computing center operated in an electrical network and for being configured for controlling a processing of a plurality of calculation tasks by the computing center (1) depending on at least one of a prioritization value respectively assigned to each one of the plurality of calculation tasks and a calculation complexity respectively assigned to each one of the plurality of calculation tasks, and (2) as a function of a power provision parameter of the electrical network
